(19) United States
(12) Patent Application Publication
(10) Pub. No.: US 2024/0359409 A1
(43) Pub. Date: Oct. 31, 2024

(54) METHOD FOR MANUFACTURING THREE-DIMENSIONAL OBJECT

(71) Applicant: SEIKO EPSON CORPORATION, Tokyo (JP)

(72) Inventor: Wataru ENDO, Shiojiri (JP)

(21) Appl. No.: 18/646,871

(22) Filed: Apr. 26, 2024

(30) Foreign Application Priority Data
Apr. 28, 2023 (JP) 2023-074499

(51) Int. Cl. B29C 64/40; B29C 64/336; B29C 64/386; B33Y 10/00; B33Y 50/00

(52) U.S. Cl. CPC B29C 64/40; B29C 64/336; B29C 64/386; B33Y 10/00; B33Y 50/00

(57) ABSTRACT

A method for manufacturing a three-dimensional object includes: a first modeling step of extruding a first modeling material to model a raft layer on a modeling surface of a stage; and a second modeling step of extruding a second modeling material and depositing a modeling layer on the raft layer to model an object. The raft layer is separated from the object after the second modeling step is completed. The first modeling step includes at least one of modeling the raft layer by separately modeling a base layer in contact with the modeling surface and a contact layer disposed above the base layer and to come into contact with the object such that at least one of a type of the first modeling material, a depositing pitch, a separation distance in a depositing direction, a modeling pattern, and a condition for layer disposition in a lateral direction is different, and modeling the raft layer by separately modeling a first layer and a second layer arranged in the lateral direction under different modeling conditions.

The present application is based on, and claims priority from JP Application Serial Number 2023-074499, filed Apr. 28, 2023, the disclosure of which is hereby incorporated by reference herein in its entirety.

### BACKGROUND

### 1. Technical Field

The present disclosure relates to a method for manufacturing a three-dimensional object.

### 2. Related Art

Regarding a method for manufacturing a three-dimensional object, JP-A-2019-43128 describes that after a raft layer is modeled on a stage, a 3D solid model is printed on the raft layer.

JP-A-2019-43128 is an example of the related art.

The raft layer is preferably modeled such that separation of an object from the stage can be prevented and deterioration in quality of the object modeled on the raft layer can be prevented. An optimal configuration of such a raft layer varies depending on, for example, a shape and material of the stage and the object. Therefore, there has been a desire for a technique capable of modeling an appropriate raft layer depending on a situation in which a raft layer is used.

### SUMMARY

According to an aspect of the present disclosure, a method for manufacturing a three-dimensional object is provided. The method for manufacturing a three-dimensional object includes: a first modeling step of extruding a first modeling material to model a raft layer on a modeling surface of a stage; and a second modeling step of extruding a second modeling material and depositing a modeling layer on the raft layer to model an object. The raft layer is separated from the object after the second modeling step is completed. The first modeling step includes at least one of modeling the raft layer by separately modeling a base layer in contact with the modeling surface and a contact layer disposed above the base layer and to come into contact with the object such that at least one of a type of the first modeling material, a depositing pitch, a separation distance in a depositing direction, a modeling pattern, and a condition for layer disposition in a lateral direction is different, and modeling the raft layer by separately modeling a first layer and a second layer arranged in the lateral direction under different modeling conditions.

### BRIEF DESCRIPTION OF THE DRAWINGS

FIG. 1 is a diagram showing a schematic configuration of a three-dimensional modeling system.

FIG. 2 is a diagram showing a schematic configuration of a material supply unit and a head.

FIG. 3 is a perspective view showing a schematic configuration of a lower surface side of a flat screw.

FIG. 4 is a schematic plan view showing an upper surface side of a barrel.

FIG. 5 is a diagram schematically showing a state in which an object is modeled.

FIG. 6 is a diagram showing a schematic configuration of an information processing apparatus.

FIG. 7 is a flowchart of modeling processing.

FIG. 8 is a schematic diagram showing a first example of a raft layer in a first embodiment.

FIG. 9 is a flowchart of data generation processing.

FIG. 10 is a diagram showing a setting screen of a raft modeling condition.

FIG. 11 is a diagram showing an example of a fill pattern.

FIG. 12 is a schematic diagram showing a second example of the raft layer in the first embodiment.

FIG. 13 is a diagram showing a state in which an inclusion area is specified.

FIG. 14 is a diagram showing a state in which the inclusion area is divided into a plurality of divided areas.

FIG. 15 is a diagram showing an interval between the divided areas.

FIG. 16 is a diagram showing a state in which each divided area is rotated.

FIG. 17 is a diagram showing a state in which an overlapping area is specified.

FIG. 18 is a diagram showing an example of a state in which raft data is generated.

FIG. 19 is a schematic diagram showing a first example of a raft layer in a second embodiment.

FIG. 20 is a schematic diagram showing a second example of the raft layer in the second embodiment.

FIG. 21 is a schematic diagram showing an example of a raft layer in a third embodiment.

### DESCRIPTION OF EMBODIMENTS

### A. First Embodiment

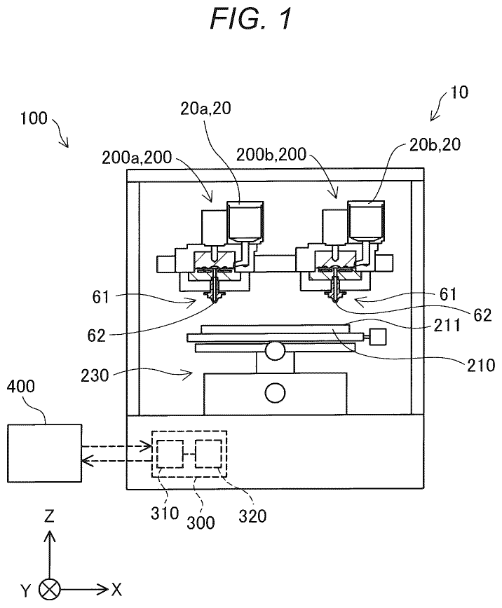

FIG. 1 is a diagram showing a schematic configuration of a three-dimensional modeling system 10 in a first embodiment. In FIG. 1, arrows indicating X, Y, and Z directions orthogonal to one another are shown. The X direction and the Y direction are directions parallel to a horizontal plane, and the Z direction is a direction along a vertically upward direction. Arrows indicating the X, Y, and Z directions are appropriately shown in other drawings in a manner in which shown directions correspond to those in FIG. 1. In the following description, when a direction is specified, a direction indicated by an arrow in each drawing is defined as “+” and an opposite direction is defined as “−”, and positive and negative signs are used in combination in a direction notation. Hereinafter, a +Z direction is also referred to as “up”, and a −Z direction is also referred to as “down”. A plane along the X direction and the Y direction is also referred to as an “XY plane”. A direction along the XY plane is also referred to as an XY direction.

The three-dimensional modeling system 10 includes a three-dimensional modeling apparatus 100 and an information processing apparatus 400. The three-dimensional modeling apparatus 100 in the embodiment is an apparatus that models a three-dimensional object by a material extrusion method. The three-dimensional modeling apparatus 100 includes a control unit 300 for controlling units of the three-dimensional modeling apparatus 100. The control unit 300 and the information processing apparatus 400 are communicably connected to each other.

The three-dimensional modeling apparatus 100 includes, in addition to the control unit 300, a first head 200a, a second head 200b, a first material supply unit 20a, a second material supply unit 20b, a stage 210, and a moving mechanism 230. Hereinafter, when the first head 200a and the second head 200b are not particularly distinguished from each other, they may be simply referred to as a head 200. Similarly, when the first material supply unit 20a and the second material supply unit 20b are not particularly distinguished from each other, they may be simply referred to as a material supply unit 20.

The control unit 300 is implemented by a computer including one or more processors, a main storage device, and an input and output interface for inputting and outputting signals from and to the outside. In the embodiment, the control unit 300 exerts various functions such as a function of executing three-dimensional modeling processing for modeling a three-dimensional object by the processor executing a program or a command read into a main storage device. By selectively using the first head 200a and the second head 200b, the control unit 300 can switch between two different materials to model a three-dimensional object. The control unit 300 may be implemented by a combination of a plurality of circuits instead of the computer.

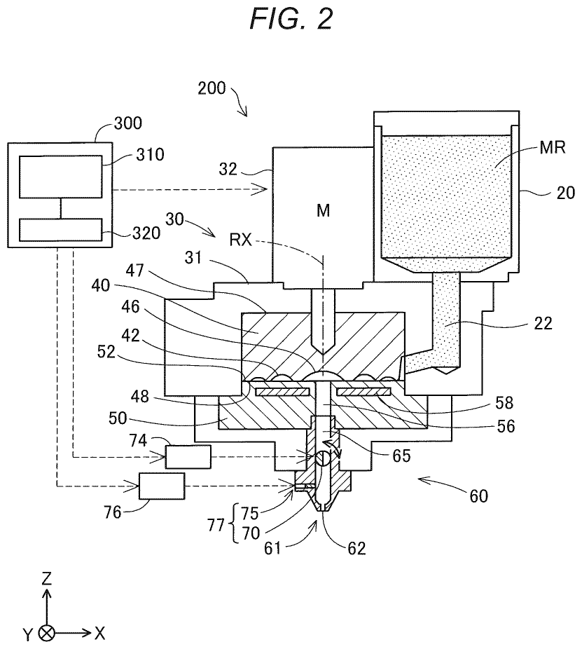

FIG. 2 is a diagram showing a schematic configuration of the material supply unit 20 and the head 200. The head 200 includes a plasticizing unit 30 and an extruding unit 60 having a nozzle 61. A material accommodated in the material supply unit 20 is supplied to the head 200. Under the control of the control unit 300, the head 200 plasticizes at least a part of the material supplied from the material supply unit 20 by the plasticizing unit 30 to generate a plasticized material, and extrudes the generated plasticized material from the nozzle 61 onto the stage 210 for deposition. In the embodiment, the term “plasticize” is a concept including melting, and is to change from a solid state to a fluid state. Specifically, in a case of a material in which glass transition occurs, the term “plasticize” refers to setting a temperature of the material equal to or higher than a glass transition point. In a case of a material in which the glass transition does not occur, the term “plasticize” refers to setting a temperature of the material equal to or higher than a melting point.

The material supply unit 20 is implemented by, for example, a hopper that accommodates a material. The material supply unit 20 is coupled to the plasticizing unit 30 via a communication path 22. The material is put into the material supply unit 20 in a form of pellets, powder, or the like. In the embodiment, a pellet-shaped ABS resin material is used. In the embodiment, the first material supply unit 20a accommodates a first material, and the second material supply unit 20b accommodates a second material. Therefore, the first material accommodated in the first material supply unit 20a is supplied to the first head 200a, and the second material accommodated in the second material supply unit 20b is supplied to the second head 200b. Hereinafter, the first material and the second material are also referred to as a raw material MR without distinction.

The plasticizing unit 30 includes a screw case 31, a drive motor 32, a flat screw 40, and a barrel 50. The flat screw 40 is also referred to as a rotor or a scroll. The barrel 50 is also referred to as a screw facing portion.

The flat screw 40 is housed in the screw case 31. An upper surface 47 of the flat screw 40 is coupled to the drive motor 32, and the flat screw 40 is rotated in the screw case 31 by a rotational drive force generated by the drive motor 32. The drive motor 32 is driven under the control of the control unit 300. The flat screw 40 may be driven by the drive motor 32 via a speed reducer.

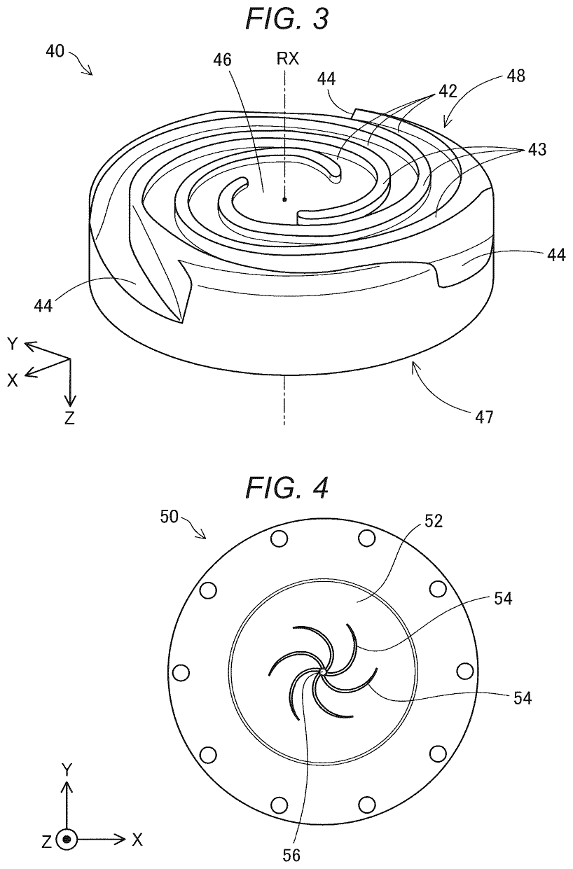

FIG. 3 is a perspective view showing a schematic configuration of a lower surface 48 side of the flat screw 40. In order to facilitate understanding of the technique, the flat screw 40 shown in FIG. 3 is shown in a state in which a positional relationship between the upper surface 47 and the lower surface 48 shown in FIG. 2 is reversed in a vertical direction. The flat screw 40 has a substantially cylindrical shape in which a length in an axial direction is smaller than a length in a direction perpendicular to the axial direction. The axial direction is a direction along a central axis of the flat screw 40. The flat screw 40 is disposed such that a rotation axis RX serving as a rotation center of the flat screw 40 is parallel to the Z direction.

Groove portions 42 in a vortex shape are formed in the lower surface 48 of the flat screw 40 that is a surface intersecting the rotation axis RX. The above-described communication path 22 of the material supply unit 20 communicates with the groove portions 42 from a side surface of the flat screw 40. In the embodiment, three groove portions 42 are formed in a manner of being separated by ridge portions 43. The number of the groove portions 42 is not limited to three, and may be one or two or more. A shape of the groove portion 42 is not limited to a vortex shape, and may have a spiral shape or an involute curve shape, or may have a shape extending in an arc from a central portion toward an outer periphery.

As shown in FIG. 1, the lower surface 48 of the flat screw 40 faces an upper surface 52 of the barrel 50, and a space is formed between the groove portions 42 of the lower surface 48 of the flat screw 40 and the upper surface 52 of the barrel 50. The raw material MR is supplied from the material supply unit 20 to the space between the flat screw 40 and the barrel 50 through material inlets 44 shown in FIG. 3.

A barrel heater 58 for heating the raw material MR supplied into the groove portions 42 of the rotating flat screw 40 is embedded in the barrel 50. A communication hole 56 is provided at a center of the barrel 50.

FIG. 4 is a schematic plan view showing the upper surface 52 of the barrel 50. A plurality of guide grooves 54 coupled to the communication hole 56 and extending in a vortex shape from the communication hole 56 toward an outer periphery are formed in the upper surface 52 of the barrel 50. One end of the guide groove 54 may not be coupled to the communication hole 56. The guide groove 54 may be omitted.

The raw material MR supplied into the groove portions 42 of the flat screw 40 flows along the groove portions 42 by the rotation of the flat screw 40 while being plasticized in the groove portions 42, and the raw material MR is guided to a central portion 46 of the flat screw 40 as a modeling material. The paste-shaped modeling material that exhibits fluidity and flows into the central portion 46 is supplied to the extruding unit 60 through the communication hole 56 provided at the center of the barrel 50. In the modeling material, not all kinds of substances constituting the modeling material may be plasticized. The modeling material may be converted into a state having fluidity as a whole by plasticizing at least a part of substances constituting the modeling material.

The extruding unit 60 includes the nozzle 61 that extrudes the modeling material, a modeling material flow path 65 formed between the flat screw 40 and a nozzle opening 62, and an extruding control unit 77 that controls extruding of the modeling material.

The nozzle 61 is coupled to the communication hole 56 of the barrel 50 through the flow path 65. Through the nozzle 61, the modeling material generated in the plasticizing unit 30 is extruded from the nozzle opening 62 at a tip end of the nozzle 61 toward the stage 210.

The extruding control unit 77 includes an extruding adjustment unit 70 that opens and closes the flow path 65, and a suction unit 75 that suctions and temporarily stores the modeling material.

The extruding adjustment unit 70 is provided in the flow path 65, and changes an opening degree of the flow path 65 by being rotated in the flow path 65. In the embodiment, the extruding adjustment unit 70 is implemented by a butterfly valve. The extruding adjustment unit 70 is driven by a first drive unit 74 under the control of the control unit 300. The first drive unit 74 is implemented by, for example, a stepping motor. The control unit 300 can adjust a flow rate of the modeling material flowing from the plasticizing unit 30 to the nozzle 61, that is, an extruding amount of the modeling material extruded from the nozzle 61, by controlling a rotation angle of the butterfly valve using the first drive unit 74. The extruding adjustment unit 70 can adjust the extruding amount of the modeling material and can control ON and OFF of an outflow of the modeling material.

The suction unit 75 is coupled between the extruding adjustment unit 70 and the nozzle opening 62 in the flow path 65. The suction unit 75 temporarily suctions the modeling material in the flow path 65 when extruding of the modeling material from the nozzle 61 is stopped, thereby preventing a tailing phenomenon in which the modeling material drips down from the nozzle opening 62 like a string. In the embodiment, the suction unit 75 is implemented by a plunger. The suction unit 75 is driven by a second drive unit 76 under the control of the control unit 300. The second drive unit 76 is implemented by, for example, a stepping motor, a rack-and-pinion mechanism that converts a rotation force of the stepping motor into a translational motion of a plunger, and the like.

As shown in FIG. 1, the stage 210 is disposed at a position facing the nozzle opening 62 of the nozzle 61. In the first embodiment, a modeling surface 211 of the stage 210 facing the nozzle opening 62 of the nozzle 61 is disposed in parallel to the X and Y directions, that is, a horizontal direction. The stage 210 may include a stage heater for preventing rapid cooling of the modeling material extruded onto the stage 210.

The moving mechanism 230 changes a relative position between the stage 210 and the nozzle 61 under the control of the control unit 300. In the embodiment, a position of the nozzle 61 is fixed, and the moving mechanism 230 moves the stage 210. The moving mechanism 230 is implemented by a three-axis positioner that moves the stage 210 in three axial directions of X, Y, and Z directions by drive forces of three motors. In the present description, unless otherwise specified, a movement of the nozzle 61 refers to moving the nozzle 61 or the extruding unit 60 relative to the stage 210.

In another embodiment, a configuration in which the moving mechanism 230 moves the nozzle 61 relative to the stage 210 in a state in which a position of the stage 210 is fixed may be adopted instead of a configuration in which the stage 210 is moved by the moving mechanism 230. Further, a configuration in which the stage 210 is moved in the Z direction by the moving mechanism 230 and the nozzle 61 is moved in the X and Y directions or a configuration in which the stage 210 is moved in the X and Y directions by the moving mechanism 230 and the nozzle 61 is moved in the Z direction may be adopted. With such configurations, a relative positional relationship between the nozzle 61 and the stage 210 can also be changed.

The control unit 300 is a control device that controls an overall operation of the three-dimensional modeling apparatus 100. The control unit 300 is implemented by a computer including one or more processors 310, a storage device 320 including a main storage device and an auxiliary storage device, and an input and output interface that inputs and outputs signals to and from the outside. The processor 310 executes a program stored in the storage device 320, thereby controlling the head 200 and the moving mechanism 230 according to modeling data acquired from the information processing apparatus 400 to model an object on the stage 210. The control unit 300 may be implemented by a combination of circuits instead of being implemented by a computer.

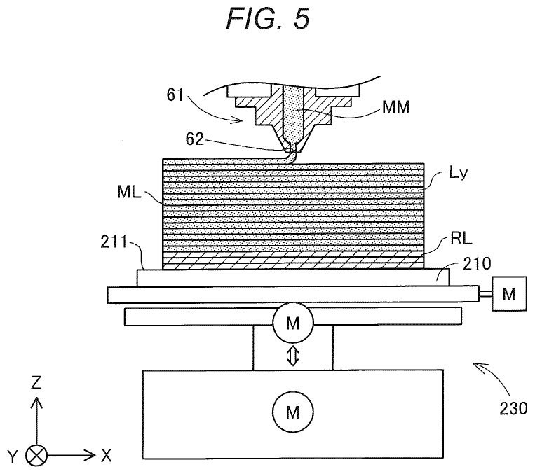

FIG. 5 is a diagram schematically showing a state in which the three-dimensional modeling apparatus 100 models an object. As described above, the raw material MR in a solid state is plasticized to generate a modeling material MM in the three-dimensional modeling apparatus 100. The control unit 300 causes the nozzle 61 to extrude the modeling material MM while changing a position of the nozzle 61 relative to the stage 210 in a direction along the modeling surface 211 of the stage 210 and maintaining a distance between the modeling surface 211 of the stage 210 and the nozzle 61. The modeling material MM extruded from the nozzle 61 is continuously deposited in a moving direction of the nozzle 61.

The control unit 300 forms layers Ly of the modeling material by repeating a movement of the nozzle 61. After forming one layer Ly, the control unit 300 moves a position of the nozzle 61 relative to the stage 210 in the Z direction. Then, the layer Ly is further stacked on the layer Ly formed so far. The control unit 300 deposits the layers Ly in this manner to deposit a raft layer RL and a modeling layer ML. In FIG. 5, the modeling layer ML is hatched with dots, and the raft layer RL is hatched with oblique lines. The raft layer RL is a layer for preventing the modeling layer ML from being separated from the stage 210 during modeling, and is modeled on the modeling surface 211 of the stage 210. The modeling layer ML is a layer Ly for forming a desired object OB, and is deposited on the raft layer RL. It can also be said that the modeling layer ML is deposited on the modeling surface 211 with the raft layer RL therebetween. The raft layer RL is separated from the object OB after the modeling of the object OB is completed.

For example, the control unit 300 may temporarily interrupt a movement of the nozzle 61 in the Z direction when the layer Ly for one layer is completed, or temporarily interrupt extruding of the modeling material from the nozzle 61 when there are a plurality of independent modeling areas in each layer. In this case, the flow path 65 is closed by the extruding adjustment unit 70, extruding of the modeling material MM from the nozzle opening 62 is stopped, and the modeling material in the nozzle 61 is temporarily suctioned by the suction unit 75. After the control unit 300 changes a position of the nozzle 61, the extruding adjustment unit 70 opens the flow path 65 while discharging the modeling material in the suction unit 75, thereby restarting stacking of the modeling material MM from a changed position of the nozzle 61.

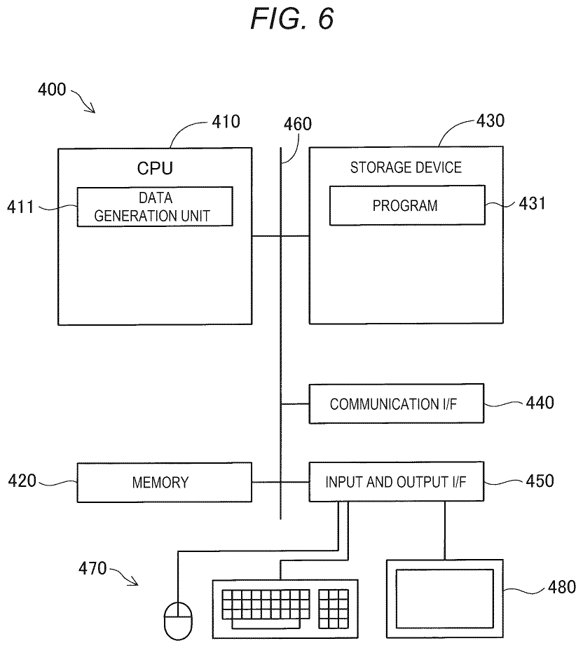

FIG. 6 is a diagram showing a schematic configuration of the information processing apparatus 400. The information processing apparatus 400 is implemented as a computer in which a CPU 410, a memory 420, a storage device 430, a communication interface 440, and an input and output interface 450 are mutually connected by a bus 460. An input device 470 such as a keyboard and a mouse and a display unit 480 implemented by a liquid crystal display, organic EL display, or the like are connected to the input and output interface 450. The information processing apparatus 400 is connected to the control unit 300 of the three-dimensional modeling apparatus 100 via the communication interface 440.

The CPU 410 functions as a data generation unit 411 by executing a program 431 stored in the storage device 430. The data generation unit 411 generates raft data, which is data for modeling a raft layer, by executing data generation processing to be described later. More specifically, the data generation unit 411 in the embodiment generates modeling data including raft data and main body data, which is data for modeling the modeling layer ML, by executing the data generation processing.

The modeling data includes path data and extruding amount information associated with the path data. The path data is data in which a moving path, which is a path along which the nozzle 61 moves while extruding the plasticized material, is represented by a plurality of partial paths. The partial path is a linear path, and is represented using, for example, a start point and an end point of the partial path. The extruding amount information is information representing an extruding amount of the plasticized material in each partial path. The modeling data is represented by, for example, a G code. Hereinafter, the path data for modeling the raft layer RL, that is, the path data included in the raft data is also referred to as raft path data. The path data for modeling the modeling layer ML, that is, the path data included in the main body data is also referred to as main body path data.

The information processing apparatus 400 transmits the modeling data generated by the data generation unit 411 to the control unit 300 of the three-dimensional modeling apparatus 100. The control unit 300 controls the extruding unit 60 and the moving mechanism 230 according to the received modeling data to extrude the modeling material and deposit layers in the depositing direction, thereby modeling the raft layer RL and the modeling layer ML on the stage 210.

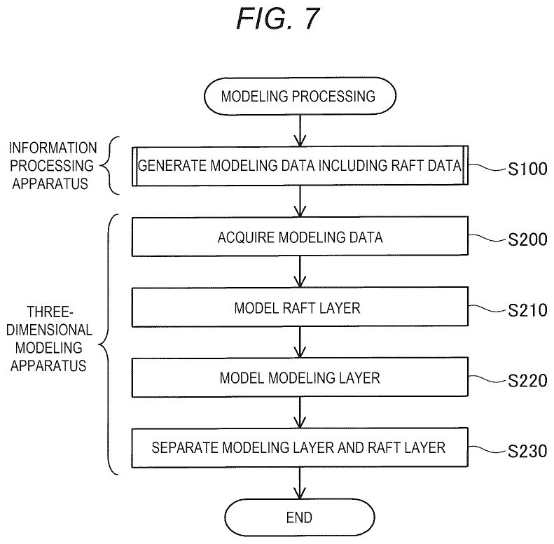

FIG. 7 is a flowchart of the modeling processing executed in the three-dimensional modeling system 10. The modeling processing is processing for implementing a method for manufacturing a three-dimensional object. The modeling processing is executed, for example, when a predetermined start operation is performed by a user on the control unit 300. The processing of step S100 shown in FIG. 7 is executed in the information processing apparatus 400, and the processing of steps S200 to S230 is executed in the three-dimensional modeling apparatus 100.

In step S100, the data generation unit 411 of the information processing apparatus 400 generates the modeling data including the raft data by executing the data generation processing. Details of the data generation processing will be described later.

In step S200, the control unit 300 of the three-dimensional modeling apparatus 100 acquires the modeling data generated in step S100 from the information processing apparatus 400. In step S210, the control unit 300 controls the extruding unit 60 and the moving mechanism 230 based on the raft data included in the modeling data acquired in step S200 to extrude the modeling material to model the raft layer RL on the modeling surface 211 of the stage 210. In step S220, the control unit 300 controls the extruding unit 60 and the moving mechanism 230 based on the main body data included in the modeling data to extrude the modeling material and model the modeling layer ML on the raft layer RL. Hereinafter, the modeling material for forming the raft layer RL is also referred to as a first modeling material, and the modeling material for forming the modeling layer ML is also referred to as a second modeling material. As in step S210, a step of extruding the first modeling material to model the raft layer RL on the modeling surface 211 is also referred to as a first modeling step. As in step S220, a step of extruding the second modeling material and depositing the modeling layer ML on the raft layer RL to model the object OB is also referred to as a second modeling step.

In step S230, the object OB and the raft layer RL are separated. That is, the raft layer RL is separated from the object OB after the second modeling step is completed. In step S230, for example, the raft layer RL and the object OB may be separated by using a robot, a cutting device, or the like provided in the three-dimensional modeling apparatus 100.

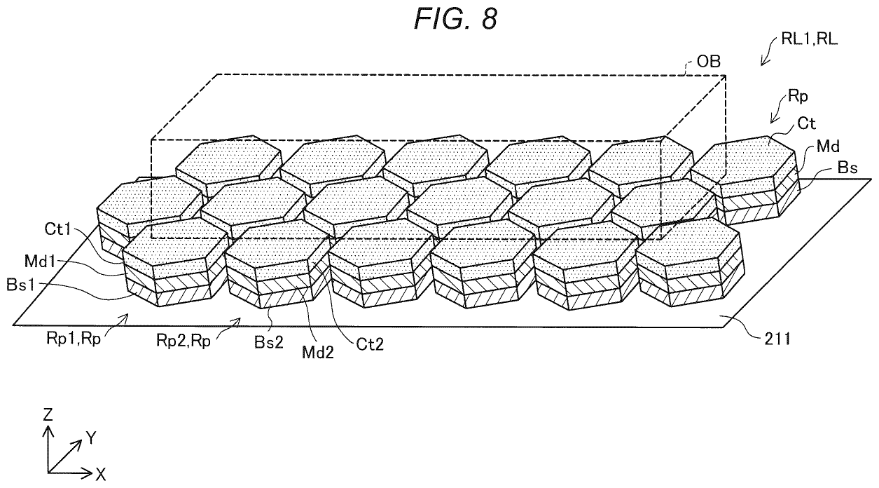

FIG. 8 is a schematic diagram showing a first example of the raft layer RL in the embodiment. FIG. 8 shows a raft layer RL1 as an example of the raft layer RL. In FIG. 8, a shape of the object OB modeled on the raft layer RL1 is schematically shown by a broken line.

In the first modeling step in the embodiment, the raft layer RL is divided and modeled in a longitudinal direction and a lateral direction. The longitudinal direction is a direction along the depositing direction, and is the Z-direction in the embodiment. The lateral direction is a direction perpendicular to the depositing direction, and is the XY direction in the embodiment. Hereinafter, the division of the raft layer RL in the longitudinal direction is also referred to as longitudinal division, and the division of the raft layer RL in the lateral direction is also referred to as lateral division.

The longitudinally divided raft layer RL includes at least a base layer Bs and a contact layer Ct. The base layer Bs is in contact with the modeling surface 211 and is not in contact with the object OB. The contact layer Ct is disposed above the base layer Bs and to come into contact with the object OB. That is, the contact layer Ct is not in contact with the modeling surface 211. The raft layer RL in the embodiment further includes a middle layer Md. The middle layer Md is disposed between the base layer Bs and the contact layer Ct, and is formed to couple the base layer Bs and the contact layer Ct in the depositing direction. The base layer Bs, the contact layer Ct, and the middle layer Md may be each formed of only one layer in the depositing direction, or may be each formed of two or more layers deposited in the depositing direction. In the embodiment, the base layer Bs and the contact layer Ct are modeled under different modeling conditions. Hereinafter, a step of modeling the base layer Bs and the contact layer Ct under different modeling conditions is also referred to as a first step. More specifically, in the first step, the base layer Bs and the contact layer Ct are separately modeled such that at least one of a type of the modeling material, a depositing pitch, a separation distance in the depositing direction, a modeling pattern, and a condition for layer disposition in the lateral direction is different. The condition for layer disposition in the lateral direction includes a number condition for the number of layers in the lateral direction, a size condition for a size of the layers in the lateral direction, and an interval condition for an interval between the layers in the lateral direction. In the embodiment, the expression “condition for layer disposition in the lateral direction is different” means that at least one of the number condition, the size condition, and the interval condition is different.

The laterally divided raft layer RL includes two or more layers arranged in the lateral direction. Two layers provided in the raft layer RL and arranged in the lateral direction are also referred to as a first layer and a second layer, respectively. The first layer and the second layer may be formed of only one layer in the depositing direction, or may be formed of two or more layers deposited in the depositing direction. As described later, the first layer and the second layer are modeled such that a path for modeling the first layer and a path for modeling the second layer are not coupled. As described above, as long as the path for modeling the first layer and the path for modeling the second layer are not coupled, the first layer and the second layer may be in contact with each other. In the embodiment, the first layer and the second layer are modeled under the same modeling condition. On the other hand, in another embodiment, the first layer and the second layer may be modeled under different modeling conditions. In this way, the step of modeling the first layer and the second layer under different modeling conditions is also referred to as a second step. The first modeling step may include at least one of the first step and the second step.

In the example of FIG. 8, the raft layer RL is formed of a plurality of divided rafts Rp arranged in the lateral direction. For example, when a first divided raft Rp1, which is one divided raft Rp, is the first layer, a second divided raft Rp2, which is another divided raft Rp, corresponds to the second layer.

The first divided raft Rp1 and the second divided raft Rp2 each include the above-described base layer Bs, contact layer Ct, and middle layer Md. The base layer Bs, the contact layer Ct, and the middle layer Md provided in the first divided raft Rp1 are also referred to as a first base layer Bs1, a first contact layer Ct1, and a first middle layer Md1, respectively. The base layer Bs, the contact layer Ct, and the middle layer Md provided in the second divided raft Rp2 are also referred to as a second base layer Bs2, a second contact layer Ct2, and a second middle layer Md2, respectively. The first base layer Bs1 and the second base layer Bs2 are the base layers Bs arranged in the lateral direction. The first contact layer Ct1 and the second contact layer Ct2 are the contact layers Ct arranged in the lateral direction. The first middle layer Md1 and the second middle layer Md2 are the middle layers Md arranged in the lateral direction. The first contact layer Ct1 and the first middle layer Md1 are disposed above the first base layer Bs1 to correspond to the first base layer Bs1. The second contact layer Ct2 and the second middle layer Md2 are disposed above the second base layer Bs2 to correspond to the second base layer Bs2. It can be said that the raft layer RL is modeled such that such disposition of the base layer Bs, the contact layer Ct, and the middle layer Md can be implemented in the first modeling step. It can be said that the raft data is generated such that such disposition of the base layer Bs, the contact layer Ct, and the middle layer Md can be implemented in the data generation step. For example, when the first contact layer Ct1 is the first layer, the second contact layer Ct2 corresponds to the second layer. The same applies to the base layer Bs and the middle layer Md.

As described above, in the embodiment, the base layer Bs and the contact layer Ct are modeled under different modeling conditions in the first modeling step. In the embodiment, the base layer Bs and the contact layer Ct are separately modeled such that separation distances are different. Details of the modeling conditions will be described later.

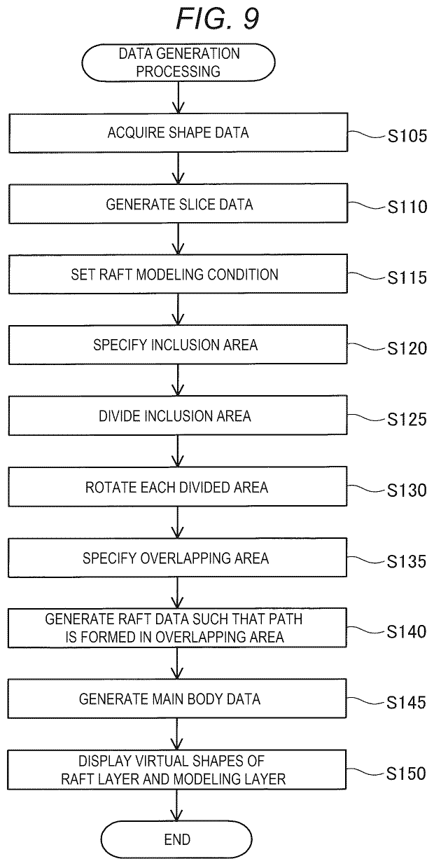

FIG. 9 is a flowchart of the data generation processing executed in step S100 in FIG. 7. In step S105, the data generation unit 411 acquires shape data representing a shape of the object OB desired to be modeled from another computer, a recording medium, or the storage device 430. In step S105, the data generation unit 411 acquires three-dimensional shape data created using three-dimensional CAD software, three-dimensional CG software, or the like as shape data. In this case, for example, data in an STL format, an AMF format, or the like can be used as the shape data. In the embodiment, the shape data is associated with information on a type of material used for modeling the object OB. In the embodiment, the entire object OB is modeled using the first material. The shape data may be data representing a shape of the object OB, and may be, for example, main body data or modeling data generated by another three-dimensional modeling apparatus or another information processing apparatus. In this case, the data generation unit 411 may obtain the shape of the object OB by analyzing the main body data or the modeling data.

In step S110, the data generation unit 411 generates slice data. The slice data refers to data representing a shape of the object OB sliced into a plurality of layers. More specifically, the data generation unit 411 generates slice data by slicing the shape of the object OB represented by the shape data into a plurality of layers along the XY plane.

From step S115 to step S140, the data generation unit 411 generates raft data.

In step S115, the data generation unit 411 displays a setting screen of a raft modeling condition on a display unit of the display unit 480, and receives, from a user, a setting of the raft modeling condition representing the modeling condition of the raft layer RL. The user operates the setting screen displayed on the display unit 480 using the input device 470 shown in FIG. 6 to set the raft modeling condition. In step S115 in the embodiment, some of setting items for the raft modeling condition are set by the user.

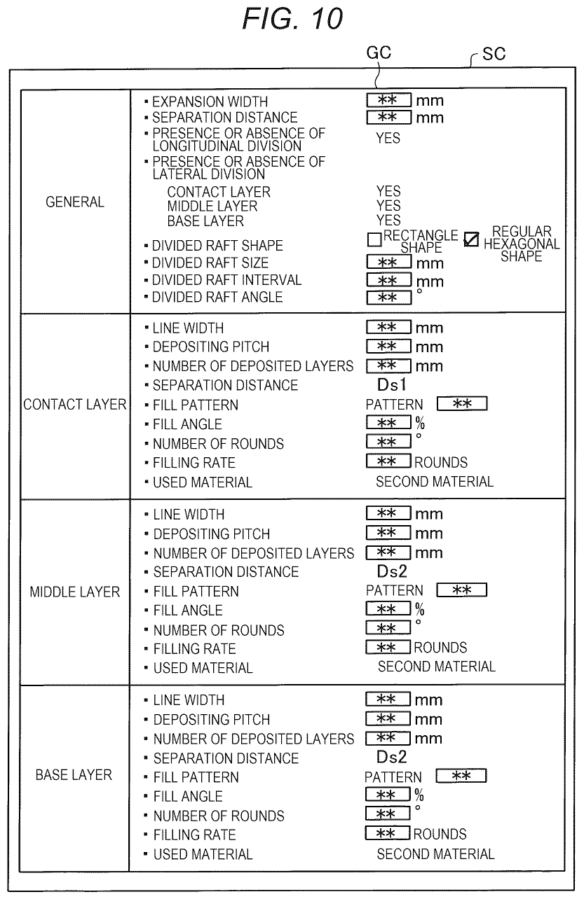

FIG. 10 is a diagram showing a setting screen SC of a raft modeling condition GC. FIG. 10 shows setting items for general, setting items for the contact layer Ct, setting items for the middle layer Md, and setting items for the base layer Bs as setting items for setting the raft modeling condition GC. In step S115, the user sets the modeling condition by, for example, inputting a numerical value for each of the above items or executing selection using a check box. Among the setting items shown in FIG. 10, some or all of the above items may not be set by the user, and may be determined by the data generation unit 411 or the control unit 300 without depending on the user.

In FIG. 10, an expansion width, presence or absence of longitudinal division, presence or absence of lateral division, a divided raft shape, a divided raft size, a divided raft interval, and a divided raft angle are shown as the setting items for general. The “expansion width” represents a width by which the raft layer RL is expanded to an outside of the object OB when viewed along the depositing direction. For example, when the expansion width is set to zero, the raft layer RL is modeled so as not to protrude to the outside of the object OB when viewed along the depositing direction. The “presence or absence of longitudinal division” is a setting item for determining whether to divide the raft layer RL in the longitudinal direction. The “presence or absence of lateral division” is a setting item for determining whether to divide the raft layer RL in the lateral direction. In the embodiment, the “presence or absence of longitudinal division” and “presence or absence of lateral division” are each set to “YES”. The “divided raft shape” represents a shape of each divided raft. In the embodiment, one of a rectangular shape and a regular hexagonal shape can be selected as the divided raft shape. The “divided raft size” represents a size of each divided raft. In the embodiment, the above-described size condition is determined based on the “divided raft shape” and the “divided raft size”. The “divided raft interval” represents a width of an interval between the divided rafts. In the embodiment, the above-described interval condition is determined based on the “divided raft interval”. The “raft angle” represents an angle at which each divided raft is rotated from a predetermined reference posture on the XY plane.

FIG. 10 shows, as the setting items for the contact layer Ct, a line width, a depositing pitch, the number of deposited layers, a separation distance, a fill pattern, a fill angle, the number of rounds of contour, a filling rate, and a used material. The “line width” represents a width of the modeling material extruded from the nozzle 61. The “depositing pitch” represents a height of each layer. The “number of deposited layers” represents the number of layers in the depositing direction. The “separation distance” represents a separation distance in the depositing direction. More specifically, the separation distance represents a distance by which the nozzle 61 is separated from an uppermost layer after the modeling. Therefore, even when the separation distance increases, no gap is formed in an actual object, and the modeling material is extruded from above by a designated distance. The separation distance is not limited to an actual dimension, and may be designated by the number of layers. In the embodiment, the separation distance for the contact layer Ct is set to a separation distance Ds1. The “fill pattern” represents a pattern indicating a moving path of the nozzle 61 for filling an inner area of each contact layer Ct. The “fill angle” is an item representing an angle of the designated fill pattern. The “number of rounds” is an item representing the number of rounds for forming a contour of each contact layer Ct. When zero is designated as the “number of rounds”, no contour is formed. The fill pattern, the fill angle, and the number of rounds are collectively referred to as a “modeling pattern”. In the present description, the expression “modeling pattern is different” means that at least one of the fill pattern, the fill angle, and the number of rounds is different. The “filling rate” represents an area ratio of the inner area of each contact layer Ct filled with the designated fill pattern. The “used material” represents a type of material used for modeling the contact layer Ct. In the embodiment, the material used for the contact layer Ct is set to the second material.

Similar to the setting items for the contact layer Ct, FIG. 10 shows the setting items for the middle layer Md and the setting items for the base layer Bs. In the embodiment, the separation distance for the middle layer Md and the base layer Bs is set to a separation distance Ds2 less than the separation distance Ds1. The material used for the middle layer Md and the base layer Bs is set to the second material, similar to the contact layer Ct.

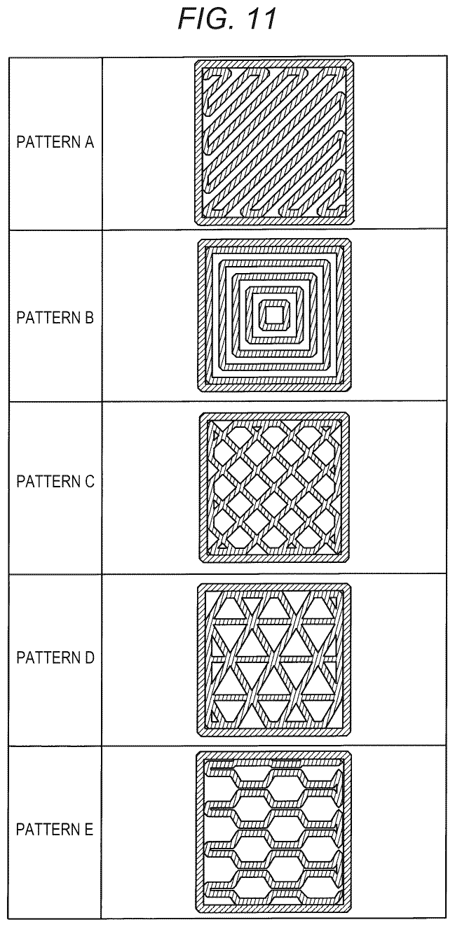

FIG. 11 is a diagram showing an example of the fill pattern. In the embodiment, different fill patterns from a pattern A to a pattern E shown in FIG. 11 can be designated as the fill patterns of the contact layer Ct, the middle layer Md, and the base layer Bs. The fill patterns shown in FIG. 11 are all examples of fill patterns disposed inside a one-round contour. When the fill patterns shown in FIG. 11 are selected, three or more partial paths in accordance with the selected fill pattern are formed in the first modeling step.

The above-described raft modeling condition set in step S115 is reflected in the raft data generated in step S140 to be described later. As a result, the raft modeling condition is reflected in a virtual shape of the raft layer RL to be described later and a shape of the raft layer RL modeled in step S210 in FIG. 7. For example, for the above-described raft layer RL1 shown in FIG. 8, the expansion width is set to a value greater than 0, the divided raft shape is set to a regular hexagonal shape, and the divided raft interval is set to a value greater than 0. When the divided raft shape is a regular hexagonal shape, an angle of a corner of the divided raft Rp is larger than when the divided raft shape is a rectangular shape, so that separation of the raft layer RL can be further prevented. For example, compared to a case where the divided raft shape is a pentagonal shape or a case where the divided raft shape is a polygonal shape with seven or more corners, the divided rafts Rp are easily regularly arranged.

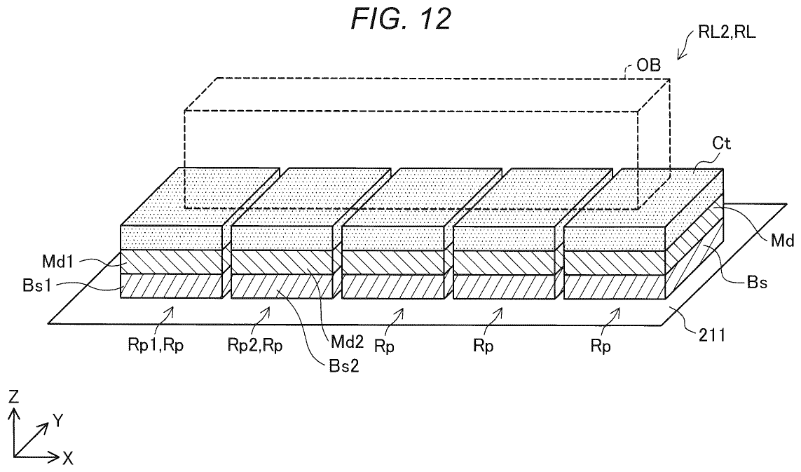

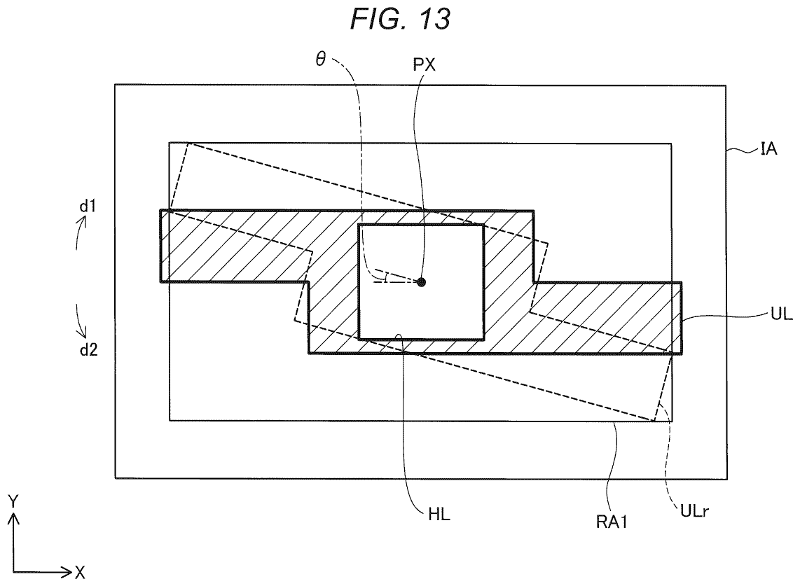

FIG. 12 is a schematic diagram showing a second example of the raft layer RL in the embodiment. FIG. 12 shows a raft layer RL2 as an example of the raft layer RL in substantially the same manner as in FIG. 8. Unlike the raft layer RL1, the raft layer RL2 shown in FIG. 12 is generated by setting the divided raft shape to a rectangular shape.

In the first modeling step, the contact layer Ct is preferably modeled such that the modeling layer ML can be prevented from being separated from the contact layer Ct during the modeling and quality of the object OB can be further improved. In the first modeling step, the base layer Bs is preferably modeled such that the raft layer RL can be prevented from being separated from the modeling surface 211 during the modeling. Therefore, the modeling conditions for the contact layer Ct and the base layer Bs are preferably set such that the above-described contact layer Ct and base layer Bs can be modeled. For example, in the embodiment, as described above, the separation distance Ds1 for the contact layer Ct is larger than the separation distance Ds2 for the base layer Bs. In this way, as the separation distance Ds1 is larger, an upper surface of the material for modeling the contact layer Ct that is extruded from the nozzle 61 is less likely to be pressed by a lower end surface of the nozzle 61. Therefore, an excessive increase in adhesion strength between the contact layer Ct and the object OB can be prevented, and the contact layer Ct can be easily separated from the object OB in step S230 in FIG. 7. Accordingly, deterioration in quality of the object OB due to the separation of the raft layer RL from the object OB can be prevented. In the embodiment, as the separation distance Ds2 is smaller, an upper surface of the material for modeling the base layer Bs that is extruded from the nozzle 61 is easily to be pressed by the lower end surface of the nozzle 61. Therefore, adhesion strength between the base layer Bs and the modeling surface 211 can be reduced, and separation of the raft layer RL during the modeling can be prevented.

In another embodiment, instead of or in addition to the separation distance between the contact layer Ct and the base layer Bs, the used material, the depositing pitch, the modeling pattern, and the like may be set differently. For example, the material used for the base layer Bs may be selected so as to further increase the adhesion strength between the base layer Bs and the modeling surface 211, and the material used for the contact layer Ct may be selected so as not to excessively increase the adhesion strength between the modeling layer ML and the contact layer Ct. For example, in order to prevent the adhesion strength between the modeling layer ML and the contact layer Ct from being excessively high, the modeling condition for the contact layer Ct may be set such that, for example, a depositing pitch is increased, a fill pattern or a fill angle having a smaller adhesion area with the modeling layer ML is used, a filling rate is decreased, or the number of layers arranged in the lateral direction is reduced by increasing an interval between the layers arranged in the lateral direction. In order to further increase the adhesion strength between the base layer Bs and the modeling surface 211, the modeling condition may be set such that, for example, a depositing pitch is reduced, a fill pattern or a fill angle having a larger contact area with the modeling layer ML is used, a filling rate is increased, or the number of layers arranged in the lateral direction is increased by reducing an interval between the layers arranged in the lateral direction.

By modeling the middle layer Md as in the embodiment, for example, the contact layer Ct and the base layer Bs can be suitably coupled in the depositing direction. By increasing the number of layers of the entire raft layer RL by the middle layer Md, the strength of the entire raft layer RL can be further increased. When such a middle layer Md is modeled faster than the contact layer Ct and the base layer Bs, the raft layer RL can be modeled more efficiently compared to, for example, a case where the number of layers of the contact layer Ct or the base layer Bs is increased to increase the strength of the entire raft layer RL. Therefore, the modeling condition for the middle layer Md is preferably set such that the middle layer Md can be modeled more efficiently. In this case, for example, the filling rate for the middle layer Md may be lower than the filling rate for the contact layer Ct and the base layer Bs, the line width for the middle layer Md may be larger than the line width for the contact layer Ct and the base layer Bs, and the fill pattern for the middle layer Md may be set to a more linear fill pattern or a fill pattern in which a moving distance of the nozzle 61 is smaller.

In step S120 in FIG. 9, the data generation unit 411 specifies an inclusion area. The inclusion area refers to, when viewed along the depositing direction, a rectangular area including at least one of a lowermost layer area representing an area where a lowermost layer of the object OB is modeled and a contact layer area representing an area where the contact layer Ct is modeled. In the embodiment, the inclusion area is specified as a rectangular area including a lowermost layer area. In step S120, the data generation unit 411 specifies the inclusion area based on, for example, shape data or slice data.

FIG. 13 is a diagram showing a state in which an inclusion area IA is specified in step S120 in FIG. 9. In FIG. 13, a shape of a lowermost layer UL of the object OB is hatched. The lowermost layer UL shown in FIG. 13 includes a hole HL inside an outer shape thereof. In step S120 in the embodiment, the inclusion area IA is specified as an XY rectangular area that is larger than an area RA1 by a predetermined expansion dimension in the X direction and the Y direction and includes the lowermost layer UL. The XY rectangular area refers to a rectangular area having two sides along the X direction and two sides along the Y direction. The area RA1 is a minimum XY rectangular area including a rotated lowermost layer ULr when viewed along the depositing direction. The rotated lowermost layer ULr represents the lowermost layer UL rotated by an angle θ in a direction d1 around a point PX in the XY plane. The point PX is defined as, for example, a center of gravity of an outer shape of the lowermost layer ULr. The angle θ is an angle corresponding to the raft angle set in step S120. More specifically, the angle θ has an absolute value same as that of the raft angle, and positive and negative represent opposite angles. Dimensional differences between the inclusion area IA and the area RA1 in the X direction and the Y direction, that is, the above-described expansion dimensions are determined based on, for example, an expansion width included in the raft modeling condition GC.

In step S125 in FIG. 9, the data generation unit 411 divides the inclusion area IA specified in step S120 into a plurality of divided areas.

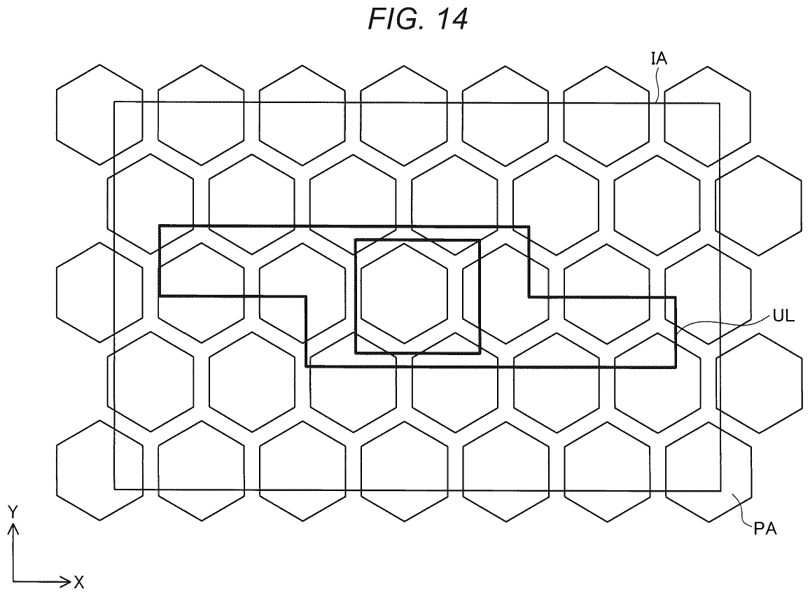

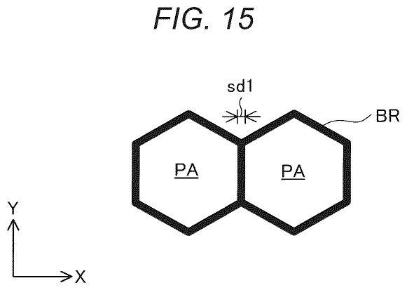

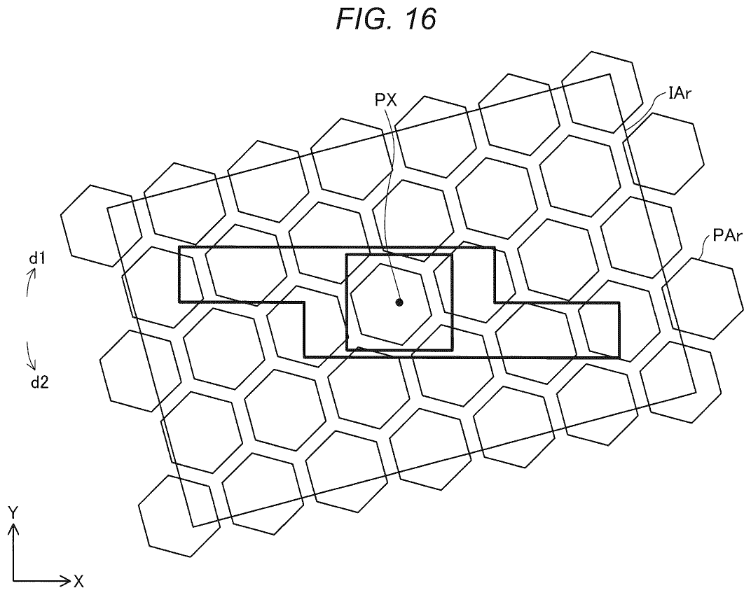

FIG. 14 is a diagram showing a state in which the inclusion area IA is divided into a plurality of divided areas PA in step S125 in FIG. 9. FIG. 15 is a diagram showing an interval sd1 between the divided areas PA. In step S125, the inclusion area IA is divided into the plurality of divided areas PA such that each divided area PA has a predetermined shape and size and the divided areas PA are disposed at predetermined intervals. Each divided area PA is generated such that a part thereof overlaps the inclusion area IA. For example, in FIG. 14, in the divided area PA generated in the vicinity of an outer edge of the inclusion area IA, only a part of the area thereof overlaps the inclusion area IA, and in the divided area PA generated inside the divided areas PA, an entire area thereof overlaps the inclusion area IA. A shape of the divided area PA is determined based on the divided raft shape set in step S115 in FIG. 9. In the example in FIG. 14, the divided areas PA each have a regular hexagonal shape. Similarly, the shape of the divided area PA is determined based on the divided raft size set in step S115. Similarly, the interval sd1 is determined based on the divided raft interval set in step S115. In step S125 in the embodiment, the interval sd1 is adjusted by adjusting a width of a boundary BR between the divided areas PA shown in FIG. 15 based on the divided raft interval.

In step S130 in FIG. 9, the data generation unit 411 rotates each divided area PA generated in step S125 by an angle same as the angle θ in a direction d2 opposite to a direction d1, with the point PX as a rotation center. In step S130, each divided area PA is rotated, for example, by rotating the inclusion area IA together with each divided area PA.

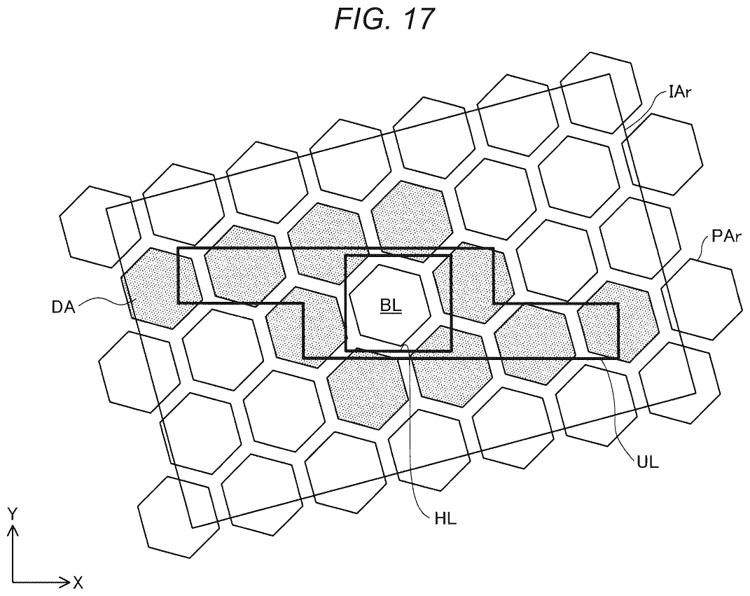

FIG. 16 is a diagram showing a state in which each divided area PA is rotated in step S130 in FIG. 9. FIG. 16 shows an inclusion area IAr representing the inclusion area IA rotated in step S130 and divided areas PAr representing the divided areas PA rotated in the same manner. The divided area PAr is inclined with respect to the divided area PA by an angle corresponding to the set divided raft angle when viewed along the depositing direction.

In step S135 in FIG. 9, the data generation unit 411 specifies an overlapping area. The overlapping area is an area where at least one of the above-described lowermost layer area and contact layer area and the divided area PA overlap when viewed along the depositing direction. More specifically, the overlapping area specified in the embodiment is an area where the lowermost layer area and at least a part of the divided area PAr overlap.

FIG. 17 is a diagram showing a state in which an overlapping area DA is specified in step S135 in FIG. 9. In FIG. 17, the overlapping area DA is hatched with a dot pattern. As shown in FIG. 17, an area outside an outer shape of the lowermost layer UL and a blank area BL are not specified as the overlapping area DA. The blank area BL is an area where the divided area PAr and the hole HL of the lowermost layer UL overlap when viewed along the depositing direction, and is an area different from the overlapping area DA.

For example, when the divided raft angle is set to zero degrees, step S130 in FIG. 9 may be omitted. In this case, in step S120, for example, an XY rectangular area including the lowermost layer UL shown in FIG. 13 may be specified as the inclusion area IA.

In step S140 in FIG. 9, the data generation unit 411 generates the raft data. In step S140, the data generation unit 411 generates the raft data such that a layer is formed in the overlapping area DA when forming the raft layer RL according to the raft data in the subsequent first modeling step. More specifically, in step S140, the data generation unit 411 generates the raft data such that a path for modeling the raft layer RL is formed in the overlapping area DA.

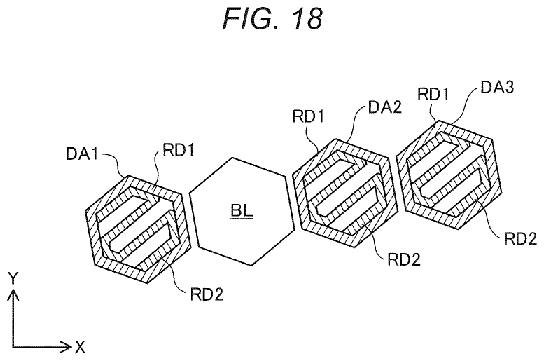

FIG. 18 is a diagram showing an example of a state in which the raft data is generated in step S140. FIG. 18 shows a first overlapping area DA1, a second overlapping area DA2, a third overlapping area DA3, and the blank area BL located between the first overlapping area DA1 and the second overlapping area DA2. The first overlapping area DA1 to the third overlapping area DA3 each represent an area where one divided area PAr and the lowermost layer UL overlap. One divided raft Rp is formed in each of the first overlapping area DA1 to the third overlapping area DA3. FIG. 18 schematically shows a state in which path data RD1 for forming a contour of the base layer Bs in each divided raft Rp and path data RD2 for forming an inner area of the contour are generated in each of the first overlapping area DA1 to the third overlapping area DA3. FIG. 18 shows that no path data is generated in the blank area BL.

In step S140 in FIG. 9, the raft path data is generated so as to satisfy the raft modeling condition set in step S115 in FIG. 9. The raft path data is generated such that the paths for forming the divided rafts Rp are not coupled with one another. For example, when the divided raft interval is set to zero, the adjacent divided rafts Rp are coupled with each other, but the paths for forming the divided rafts Rp are not coupled with one another.

In step S145 in FIG. 9, the data generation unit 411 generates the main body data. In the embodiment, when step S145 is completed, the modeling data including the raft data and the main body data is generated.

In step S150, the data generation unit 411 displays virtual shapes of the raft layer RL and the modeling layer ML on the display unit 480 based on the generated modeling data. The virtual shape of the raft layer RL is generated based on the raft data, and the virtual shape of the modeling layer ML is generated based on the main body data. The user can visually determine, based on the virtual shapes of the raft layer RL and the modeling layer ML displayed on the display unit 480, whether the generated raft data and main body data are appropriate. The virtual shapes of the raft layer RL and the modeling layer ML may be displayed on the display unit 480 such that, for example, paths for forming the respective layers provided in the raft layer RL and the modeling layer ML are visible. In another embodiment, in step S150, for example, only the virtual shape of the raft data may be displayed on the display unit 480. Step S150 may be omitted.

According to the method for manufacturing a three-dimensional object in the embodiment as described above, in the first modeling step, the base layer Bs in contact with the modeling surface 211 of the stage 210 and the contact layer Ct coming into contact with the object OB are separately modeled such that at least one of the type of the first modeling material, the depositing pitch, the separation distance in the depositing direction, the modeling pattern, and the condition for layer disposition in the lateral direction is different, thereby modeling the raft layer RL. Therefore, according to the shape, the material, and the like of the stage 210 and the object OB, for example, the contact layer Ct can be modeled under the modeling condition in which the adhesion strength between the contact layer Ct and the object OB is not excessively increased, and the base layer Bs can be modeled under the modeling condition in which the adhesion strength between the base layer Bs and the modeling surface 211 is further increased. In this way, there is a high possibility that an appropriate raft layer RL can be modeled depending on a situation in which the raft layer RL is used.

In the embodiment, the first modeling step includes a step of modeling the first base layer Bs1 and the second base layer Bs2 arranged in the lateral direction and the first contact layer Ct1 and the second contact layer Ct2 arranged in the lateral direction. In this way, since the first base layer Bs1 and the second base layer Bs2 are separately modeled as separate layers, the separation of the raft layer RL from the stage 210 due to the separation of the base layer Bs during the modeling can be prevented, for example, compared to a case where the raft layer RL includes only one base layer Bs. Since the first contact layer Ct1 and the second contact layer Ct2 are separately modeled as separate layers, the separation of the raft layer RL from the stage 210 due to the separation of the contact layer Ct during the modeling can be prevented, for example, compared to a case where the raft layer RL includes only one contact layer Ct. Therefore, the separation of the object OB from the stage 210 during the modeling can be further prevented by the raft layer RL.

The embodiment also includes the step of displaying the setting screen of the raft modeling condition on the display unit 480 and receiving the setting of the raft modeling condition. Therefore, it is possible to present the raft modeling condition to the user and receive the setting of the raft modeling condition. More specifically, in the embodiment, the setting items of the modeling condition for the contact layer Ct and the setting items of the modeling condition for the base layer Bs are separately displayed on the display unit 480, and the settings for each item are individually received. Therefore, the user can easily set the modeling conditions of the contact layer Ct and the base layer Bs.

In the embodiment, in the raft data generation step executed prior to the first modeling step, the raft data is generated such that the inclusion area IA is specified, the specified inclusion area IA is divided into the plurality of divided areas PA such that at least a part of each of the divided areas PA overlaps the inclusion area IA, and the raft layer RL is modeled in the area where the lowermost layer UL of the object OB and the divided area PA overlap in the first modeling step. Therefore, it is possible to prevent shortage of the raft layer RL and generation of the extra raft layer RL. By preventing the generation of the extra raft layer RL, a data size of the raft data and an amount of the material used for modeling the raft layer RL in the first modeling step can be reduced.

### B. Second Embodiment

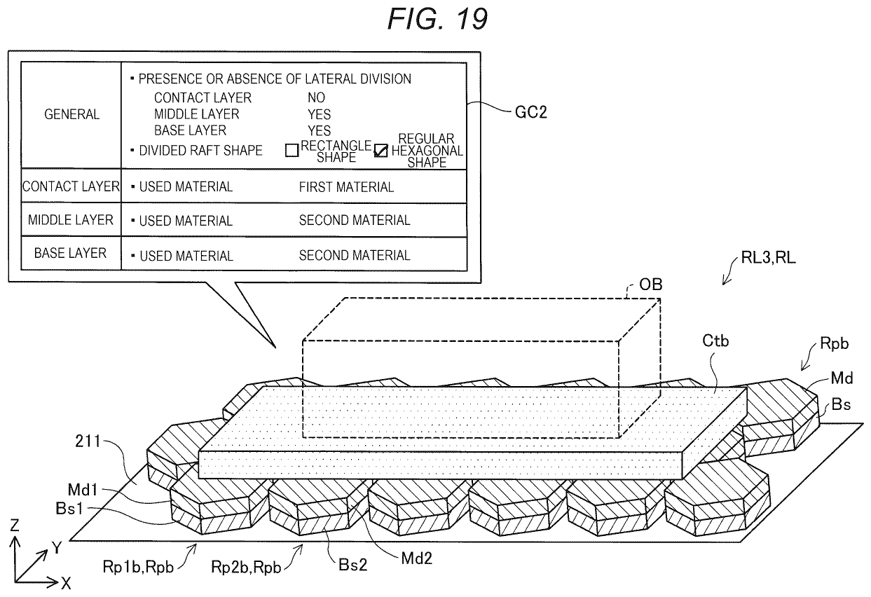

FIG. 19 is a schematic diagram showing a first example of the raft layer RL in a second embodiment. FIG. 19 shows a raft layer RL3 as an example of the raft layer RL in substantially the same manner as in FIG. 8. FIG. 19 shows a part of a raft modeling condition GC2 set for modeling the raft layer RL3. In the embodiment, unlike the first embodiment, a contact layer Ctb is not divided in a lateral direction. In the embodiment, the contact layer Ctb is modeled using the first material instead of the second material. In the three-dimensional modeling apparatus 100 and the information processing apparatus 400 in the embodiment, portions not particularly described are the same as those in the first embodiment.

As shown in FIG. 19, in the embodiment, lateral division of the contact layer is set to “NO” in the raft modeling condition GC2. On the other hand, lateral division of a middle layer and a base layer is set to “YES” as in the first embodiment. In the embodiment, the first material is set as a material used for the contact layer Ct. On the other hand, as the material used for the middle layer Md and the base layer Bs, the second material is set as in the first embodiment. In the embodiment, raft data is generated in step S140 in FIG. 9 based on the raft modeling condition GC2 set in this way, and the raft layer RL3 is modeled in step S10 in FIG. 7 based on the raft data.

In the example shown in FIG. 19, the raft layer RL3 including a plurality of divided rafts Rpb arranged in the lateral direction and one contact layer Ctb is modeled in the first modeling step according to the raft modeling condition GC2. Each divided raft Rpb does not include a contact layer, and includes the base layer Bs and the middle layer Md. In substantially the same manner as in the first embodiment, when a first divided raft Rp1b, which is one divided raft Rpb, is the first layer, a second divided raft Rp2b, which is another divided raft Rpb, corresponds to the second layer. The contact layer Ctb is deposited above the plurality of divided rafts Rpb. That is, it can be said that, in the raft layer RL3, the contact layer Ctb extends over a plurality of base layers Bs including the first base layer Bs1 and the second base layer Bs2. It can also be said that, in the raft layer RL3, the base layer Bs and the contact layer Ctb are modeled such that a number condition among a condition for layer disposition in the lateral direction is different. In the example shown in FIG. 19, the contact layer Ctb is modeled using a material that is the same as a material used for modeling the lowermost layer UL of the object OB and is different from a material used for modeling the middle layer Md and the base layer Bs. That is, the contact layer Ctb is modeled using the first material, similar to the lowermost layer of the object OB.

In order to generate the raft data for modeling the raft layer RL2, in step S120 in FIG. 9, for example, first, an area obtained by expanding the area RA1 based on an expansion width is specified, based on shape data, as an area where the contact layer Ctb is modeled. Thereafter, an inclusion area is specified as a rectangular area including a contact layer area where the contact layer Ctb is modeled. Then, in step S135, an area where the contact layer area and the divided area overlap is specified as an overlapping area. More specifically, in step S135, for example, an area where the contact layer area and at least a part of the divided area overlap is specified as the overlapping area. In the overlapping area thus specified, raft path data for modeling the base layer Bs and the middle layer Md is generated. In the contact layer area, the raft path data for modeling the contact layer Ctb is generated.

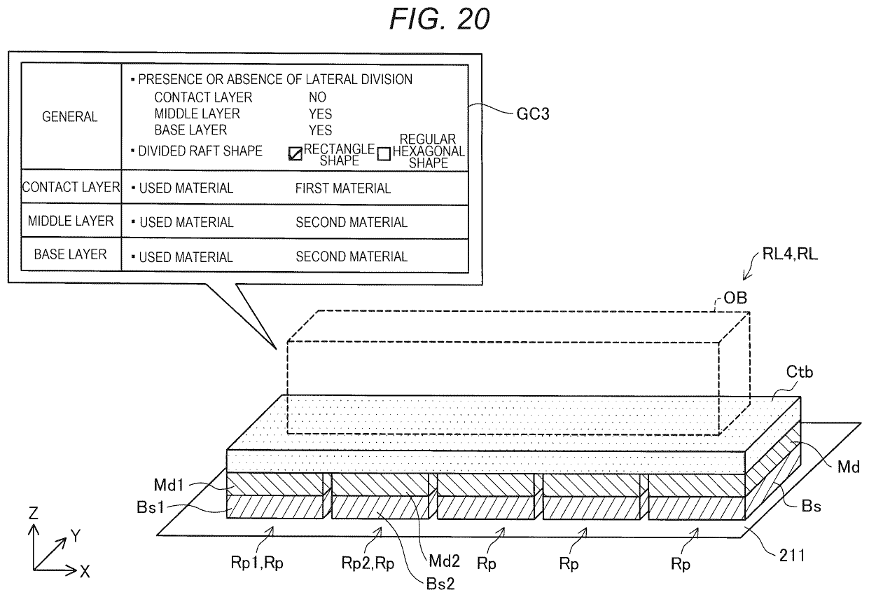

FIG. 20 is a schematic diagram showing a second example of the raft layer RL in the second embodiment. FIG. 20 shows a raft layer RL4 as an example of the raft layer RL in substantially the same manner as in FIG. 19. FIG. 20 shows a part of a raft modeling condition GC3 set for modeling the raft layer RL4. As shown in FIG. 20, unlike the raft layer RL3, the raft layer RL4 is generated by setting a divided raft shape to a rectangular shape.

According to the method for manufacturing a three-dimensional object in the embodiment as described above, the first modeling step includes a step of modeling the first base layer Bs1 and the second base layer Bs2 arranged in the lateral direction and the contact layer Ctb extending over the first base layer Bs1 and the second base layer Bs2. In this way, separation of the raft layer RL from the stage 210 due to separation of the base layer Bs during the modeling can be prevented. Since the contact layer Ct is modeled across the first base layer Bs1 and the second base layer Bs2, a boundary portion between the contact layers can be reduced or eliminated as compared with a case where the contact layer is modeled one-to-one for each base layer Bs. Therefore, in the second modeling step, the modeling layer can be prevented from coming into close contact with the boundary portion so as to bite into the boundary portion. By preventing such adhesion, deterioration in quality of the object OB can be prevented when separating the raft layer RL from the object OB. As described above, in the embodiment, there is a high possibility that the quality of the object OB can be further improved while the separation of the object OB from the stage 210 can be prevented by the raft layer RL.

In the embodiment, the material used for modeling the contact layer Ctb is different from the material used for modeling the base layer Bs, and is the same as the material used for modeling the lowermost layer of the object OB. When the material used for modeling the contact layer Ctb and the material used for modeling the lowermost layer of the object OB are the same material, the contact layer Ctb and the lowermost layer of the object OB can be modeled with the same color and texture. Therefore, a portion of the object OB that is in contact with the raft layer RL can be prevented from being contaminated by the material used for modeling the raft layer RL. In the embodiment, for example, even when a part of the raft layer RL remains attached to the object OB after the raft layer RL is separated from the object OB, the quality of the object OB can be easily improved by removing such a residue by polishing or cutting.

As in the embodiment, when the material same as the material used for modeling the lowermost layer of the object OB is used for modeling the contact layer Ctb, adhesion strength between the contact layer Ctb and the object OB is easily increased. Therefore, the modeling condition for the contact layer Ctb is preferably set such that the adhesion strength between the contact layer Ctb and the object OB is not excessively increased. In this case, for example, in addition to or instead of reducing the number of layers arranged in the lateral direction by increasing the interval between layers arranged in the lateral direction as described above, the modeling condition for the contact layer Ctb may be set such that a depositing pitch is increased, a fill pattern or a fill angle having a smaller contact area with the object OB is used, and a filling rate is decreased. In another embodiment, for example, the contact layer may be laterally divided as in the first embodiment, and the material different from the material used for modeling the base layer and same as the material used for modeling the lowermost layer of the object OB may be used for modeling each contact layer as in the second embodiment.

### C. Third Embodiment

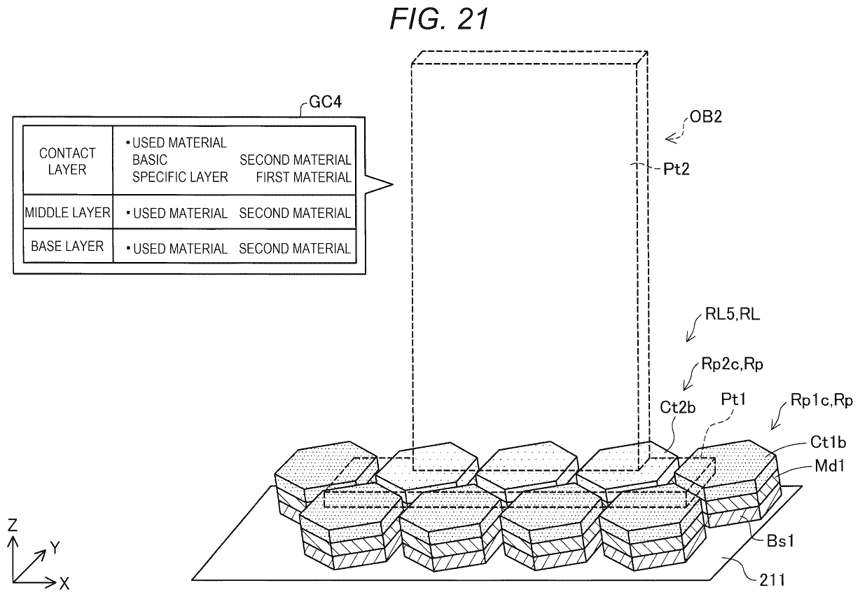

FIG. 21 is a schematic diagram showing an example of the raft layer RL in a third embodiment. FIG. 21 shows a raft layer RL5 as an example of the raft layer RL in substantially the same manner as in FIG. 19. FIG. 21 shows a part of a raft modeling condition GC4 set for modeling the raft layer RL5. Unlike the first embodiment, the first modeling step in the embodiment includes a step of modeling the first contact layer Ct and the second contact layer Ct arranged in a lateral direction under different modeling conditions. In the three-dimensional modeling apparatus 100 and the information processing apparatus 400 in the embodiment, portions not particularly described are the same as those in the first embodiment.

Similar to the object OB, an object OB2 is modeled using the first material. The object OB2 includes a first portion Pt1 and a second portion Pt2 higher than the first portion Pt1. In the embodiment, a second contact layer Ct2b of a second divided raft Rp2c is in contact with the second portion Pt2. A first contact layer Ct1b of a first divided raft Rp1c is in contact with the first portion Pt1 and is not in contact with the second portion Pt2.

As shown in FIG. 21, in the raft modeling condition GC4 in the embodiment, a basic material and a material for a specific layer can be individually set as a material used for the contact layer. The specific layer refers to the contact layer Ct in contact with the second portion Pt2 among the plurality of contact layers Ct. The “material for a specific layer” represents a material used for modeling the specific layer. The “basic material” represents a material used for modeling a layer other than the specific layer among the plurality of contact layers Ct. That is, the material set as the “basic material” is used for modeling a layer that is in contact with the first portion Pt1 and not in contact with the second portion Pt2 among the plurality of contact layers Ct.

In the embodiment, the second material is set as the “basic material”, and the first material is set as the “material for a specific portion”. Therefore, the second material is used for modeling the second contact layer Ct2b corresponding to the specific layer, and the first material is used for modeling the first contact layer Ct1b not corresponding to the specific layer. That is, in the embodiment, the first contact layer Ct1b and the second contact layer Ct2b are separately modeled under different modeling conditions, more specifically, using different materials, respectively. It can be said that, in the embodiment, the first divided raft Rp1c and the second divided raft Rp2c are separately modeled under different modeling conditions. In the embodiment, the material used for modeling the layer in contact with the second portion Pt2 is different from the material used for modeling the layer that is in contact with the first portion Pt1 and not in contact with the second portion Pt2, and is the same as the material used for modeling the lowermost layer of the object OB2.

According to the method for manufacturing a three-dimensional object in the embodiment as described above, the first modeling step includes a step of modeling the first contact layer Ct1 and the second contact layer Ct2 arranged in the lateral direction under different modeling conditions. In this way, for example, the first contact layer Ct1 and the second contact layer Ct2 can be separately modeled under different modeling conditions according to a shape of an object desired to be modeled. Therefore, the quality of the object can be further improved.

In the embodiment, the material used for modeling the layer of the raft layer RL that is in contact with the second portion Pt2 higher than the first portion Pt1 is different from the material used for modeling the layer that is in contact with the first portion Pt1 and not in contact with the second portion Pt2, and is the same as the material used for modeling the lowermost layer of the object OB. In this way, adhesion strength between the raft layer RL and the second portion Pt2 higher in height in the object OB2 can be further increased, thereby making a posture of the object OB2 more stable during modeling. In order to model the layer that is in contact with the first portion Pt1 and not in contact with the second portion Pt2, a material different from the material used for modeling the layer in contact with the second portion is used, and thus the separability of the raft layer RL from the modeling layer ML can be improved. For example, a more inexpensive material can be used for modeling the layer that is in contact with the first portion and not in contact with the second portion.

### D. Other Embodiments

(D-1) In the first modeling step in the above-described embodiment, the first step is executed. On the other hand, in the first modeling step, the first step may not be executed, and for example, only the second step may be executed. Even by executing only the second step, the first layer and the second layer arranged in the lateral direction can be separately modeled as separate layers, so that separation of the raft layer RL from the stage 210 can be prevented. Since the first layer and the second layer can be separately modeled under different modeling conditions, for example, when the first layer and the second layer are modeled such that adhesion strength between the modeling surface 211 and a layer of the first layer and the second layer that is modeled in the vicinity of an outer portion of the object OB is further increased when viewed along the depositing direction, the object OB can be prevented from being separated from the stage 210 due to separation of the raft layer RL. When the first layer and the second layer are modeled such that adhesion strength between the object OB and a layer of the first layer and the second layer that is modeled in the vicinity of an inner portion of the object OB does not become excessively high, deterioration in quality of the object OB can be prevented when separating the raft layer RL from the object OB.

When only the second step is executed, for example, as described in the third embodiment, a material that is different from the material used for modeling a layer of the raft layer RL that is in contact with the second portion Pt2 of the object OB2 and the material used for modeling a layer that is in contact with the first portion Pt1 and not in contact with the second portion Pt2, and is the same as the material used for shaping the lowermost layer of the shaped object OB can also be used. In this way, as in the third embodiment, a posture of the object OB2 during the modeling can be further stabilized and separability of the raft layer RL from the modeling layer ML can be improved. For example, a more inexpensive material can be used for modeling the layer that is in contact with the first portion and not in contact with the second portion. By using a material having a higher adhesion strength to the modeling surface 211 in the modeling of the layer that is in contact with the first portion Pt1 and not in contact with the second portion Pt2, the entire raft layer RL can be prevented from being separated from the stage 210.

(D-2) In the first modeling step in the above-described embodiment, lateral division may not be executed. That is, in the first modeling step, only one raft layer including the base layer Bs and the contact layer Ct may be modeled as the raft layer RL. In this case, the base layer Bs and the contact layer Ct in the raft layer are modeled such that at least one of a type of a modeling material, a depositing pitch, a separation distance, and a modeling pattern is different.

(D-3) In the data generation step in the above-described embodiment, raft data is generated such that the inclusion area IA, which is a rectangular area, is specified, the inclusion area IA is divided, and the overlapping area DA is specified, and the raft layer RL is formed in an area where the lowermost layer UL and the divided area PA overlap in the first modeling step. On the other hand, the raft data may not be generated in this manner. For example, an area other than a rectangular area may be specified as an area including the lowermost layer of the object OB, the area may be divided, and the raft data may be generated based on a division result thereof. For example, after the inclusion area IA is divided into a plurality of divided areas PA, without specifying the overlapping area DA, the raft data may be generated such that raft path data is generated for all the divided areas PA. When lateral division is not executed, the raft data may be generated without dividing the area including the lowermost layer of the object OB. For example, the raft data may not be generated in the three-dimensional modeling system 10, and the raft layer RL may be modeled using raft data acquired from another computer, a recording medium, or the storage device 430 in the first modeling step.

(D-4) In the above-described embodiment, the three-dimensional modeling apparatus 100 may include three or more heads 200. In this way, a material different from the first material or the second material can be used for modeling the modeling layer ML or the raft layer RL.

(D-5) In the above-described embodiment, the head 200 plasticizes a material by the flat screw 40. On the other hand, the head 200 may plasticize the material by rotating an in-line screw, for example. The head 200 may plasticize a filament-shaped material with a heater.

(D-6) In the above-described embodiment, a material extrusion method in which plasticized materials are deposited is described as an example, and the present disclosure can be applied to various methods such as an inkjet method, a direct metal deposition (DMD) method, and a binder jet method.

### E. Other Embodiments

The present disclosure is not limited to the above-described embodiments, and can be implemented in various aspects without departing from the spirit of the present disclosure. For example, the present disclosure can be implemented in the following aspects. In order to solve a part of or all of problems of the present disclosure, or to achieve a part of or all of effects of the present disclosure, technical features of the embodiments described above corresponding to technical features in the following aspects can be replaced or combined as appropriate. Unless the technical features are explained as essential technical features in the specification, the technical features can be deleted as appropriate.

(1) According to an aspect of the present disclosure, a method for manufacturing a three-dimensional object is provided. The method for manufacturing a three-dimensional object includes: a first modeling step of extruding a first modeling material to model a raft layer on a modeling surface of a stage; and a second modeling step of extruding a second modeling material and depositing a modeling layer on the raft layer to model an object. The raft layer is separated from the object after the second modeling step is completed. The first modeling step includes at least one of modeling the raft layer by separately modeling a base layer in contact with the modeling surface and a contact layer disposed above the base layer and to come into contact with the object such that at least one of a type of the first modeling material, a depositing pitch, a separation distance in a depositing direction, a modeling pattern, and a condition for layer disposition in a lateral direction is different, and modeling the raft layer by separately modeling a first layer and a second layer arranged in the lateral direction under different modeling conditions.

According to such an aspect, the base layer and the contact layer can be separately modeled under different modeling conditions, and the first layer and the second layer can be separately modeled under different modeling conditions. Therefore, depending on a situation in which a raft layer is used, there is a high possibility that an appropriate raft layer can be modeled such that separation of the object from the stage and deterioration in quality of the object modeled on the raft layer can be prevented.

(2) In the above-described aspect, the first modeling step may include modeling a first base layer and a second base layer arranged in the lateral direction and a first contact layer and a second contact layer arranged in the lateral direction. According to such an aspect, since the first base layer and the second base layer are separately modeled as separate layers, separation of the raft layer from the stage due to separation of the base layer during modeling can be prevented. Since the first contact layer and the second contact layer are separately modeled as separate layers, the separation of the raft layer from the stage due to the separation of the contact layer during the modeling can be prevented. Therefore, the separation of the object from the stage can be further prevented by the raft layer.

(3) In the above-described aspect, the first modeling step may include modeling a first base layer and a second base layer arranged in the lateral direction and the contact layer extending over the first base layer and the second base layer. According to such an aspect, since the first base layer and the second base layer are separately modeled as separate layers, separation of the raft layer from the stage due to separation of the base layer during modeling can be prevented. Since the contact layer is modeled across the first base layer and the second base layer, a boundary portion between the contact layers can be reduced or eliminated. Therefore, there is a high possibility that quality of the object can be further improved while the separation of the object from the stage is prevented by the raft layer.

(4) In the above-described aspect, a material used for modeling the contact layer may be different from a material used for modeling the base layer and may be same as a material used for modeling a lowermost layer of the object. According to such an aspect, a portion of the object that is in contact with the raft layer can be prevented from being contaminated by the material used for modeling the raft layer.

(5) In the above-described aspect, the first modeling step may include separately modeling a first contact layer and a second contact layer arranged in the lateral direction under different modeling conditions. According to such an aspect, the first contact layer and the second contact layer can be separately modeled under different modeling conditions, depending on the shape of the object, for example. Therefore, the quality of the object can be further improved.

(6) In the above-described aspect, the object may include a first portion and a second portion having a height higher than that of the first portion, and a material used for modeling a layer of the raft layer that is in contact with the second portion may be different from a material used for modeling a layer of the raft layer that is in contact with the first portion and not in contact with the second portion, and may be same as a material used for modeling a lowermost layer of the object. According to such an aspect, adhesion strength of the object between the raft layer and the second portion that is higher in height can be further increased, thereby making a posture of the object more stable during the modeling. For modeling the layer that is in contact with the first portion and not in contact with the second portion, a material that improves separability of the raft layer from the modeling layer or a material that increases adhesion strength between the raft layer and the modeling surface can be used.

(7) In the above-described aspect, the method for manufacturing a three-dimensional object includes: prior to the first modeling step, a data generation step of generating raft data used for modeling the raft layer in the first modeling step. The first modeling step includes modeling the raft layer by controlling, based on the raft data, an extruding unit configured to extrude the first modeling material. The data generation step includes specifying, when viewed along a depositing direction, a rectangular area including at least one of an area where a lowermost layer of the object is modeled and an area where the contact layer is modeled, dividing the specified rectangular area into a plurality of divided areas such that at least a part of each of the divided areas overlaps the rectangular area, and generating the raft data such that a layer is modeled in an area where the at least one area and the divided area overlap in the first modeling step. According to such an aspect, shortage of the raft layer and generation of an extra raft layer can be prevented.

What is claimed is:

1. A method for manufacturing a three-dimensional object, the method comprising:
a first modeling step of extruding a first modeling material to model a raft layer on a modeling surface of a stage; and
a second modeling step of extruding a second modeling material and depositing a modeling layer on the raft layer to model an object, wherein
the raft layer is separated from the object after the second modeling step is completed, and
the first modeling step includes at least one of
modeling the raft layer by separately modeling a base layer in contact with the modeling surface and a contact layer disposed above the base layer and to come into contact with the object such that at least one of a type of the first modeling material, a depositing pitch, a separation distance in a depositing direction, a modeling pattern, and a condition for layer disposition in a lateral direction is different, and
modeling the raft layer by separately modeling a first layer and a second layer arranged in the lateral direction under different modeling conditions.

2. The method for manufacturing a three-dimensional object according to claim 1, wherein
the first modeling step includes modeling a first base layer and a second base layer arranged in the lateral direction and a first contact layer and a second contact layer arranged in the lateral direction.

3. The method for manufacturing a three-dimensional object according to claim 1, wherein
the first modeling step includes modeling a first base layer and a second base layer arranged in the lateral direction and the contact layer extending over the first base layer and the second base layer.

4. The method for manufacturing a three-dimensional object according to claim 1, wherein
a material used for modeling the contact layer is different from a material used for modeling the base layer and is same as a material used for modeling a lowermost layer of the object.

5. The method for manufacturing a three-dimensional object according to claim 1, wherein
the first modeling step includes separately modeling a first contact layer and a second contact layer arranged in the lateral direction under different modeling conditions.

6. The method for manufacturing a three-dimensional object according to claim 1, wherein
the object includes a first portion and a second portion having a height higher than that of the first portion, and
a material used for modeling a layer of the raft layer that is in contact with the second portion is different from a material used for modeling a layer of the raft layer that is in contact with the first portion and not in contact with the second portion and is same as a material used for modeling a lowermost layer of the object.

7. The method for manufacturing a three-dimensional object according to claim 1, further comprising:
prior to the first modeling step, a data generation step of generating raft data used for modeling the raft layer in the first modeling step, wherein
the first modeling step includes modeling, based on the raft data, the raft layer by controlling an extruding unit configured to extrude the first modeling material, and
the data generation step includes
specifying, when viewed along a depositing direction, a rectangular area including at least one of an area where the lowermost layer of the object is modeled and an area where the contact layer is modeled,
dividing the specified rectangular area into a plurality of divided areas such that at least a part of each of the divided areas overlaps the rectangular area, and
generating the raft data such that a layer is modeled in an area where the at least one area and the divided area overlap in the first modeling step.
